(19) United States
(12) Patent Application Publication
(10) Pub. No.: US 2008/0058028 A1
(43) Pub. Date: Mar. 6, 2008

(54) AC ADAPTOR

(76) Inventors: Akiya NAKAYAMA, Fukuoka (JP); Eiji YOSHIDA, Fukuoka (JP); Takashi TAMURA, Fukuoka (JP); Katsutoshi INADA, Fukuoka (JP)

Correspondence Address: LADAS & PARRY LLP, 224 SOUTH MICHIGAN AVENUE, SUITE 1600, CHICAGO, IL, 60604, US

(21) Appl. No.: 11/830,084

(22) Filed: Jul. 30, 2007

(30) Foreign Application Priority Data
Aug. 31, 2006 (JP) 2006-236026

(51) Int. Cl. H02J 7/02

(52) U.S. Cl. 455/573

(57) ABSTRACT

A switching regulator circuit assembly housed in a case is disclosed. The assembly includes a first and a second circuit board assemblies each having a circuit board on which electronic parts are mounted and an insulator member having an electronic parts enclosing part for enclosing the electronic parts. The first and second electronic board assemblies are fixed to each other with the insulator member disposed in between; accordingly the electronic parts are enclosed in the electronic parts enclosing part.

### BACKGROUND OF THE INVENTION

1. Field of the Invention

The present invention generally relates to an AC adaptor, and more particularly to a compact AC adaptor used for, for example, charging a cell phone.

2. Description of the Related Art

A conventional AC adaptor includes a switching regulator circuit assembly housed in a case made of synthetic resin. It is desired to reduce the size of the AC adaptor.

In one example of an AC adaptor whose size is reduced, an included switching regulator circuit assembly is divided into two; that is, a first circuit board assembly and a second circuit board assembly. The assemblies are connected to each other by an electric cable. In this structure, the first circuit board assembly is housed in a case, and the second circuit board assembly is also housed in the case. Electronic parts on the first circuit board assembly and electronic parts on the second circuit board assembly are disposed opposite to each other with a plate-like insulator member disposed in between the case. Accordingly, the size of such an AC adaptor becomes smaller than that of a conventional AC adaptor that includes a switching regulator circuit board assembly having one single larger circuit board.

Patent Document 1: Japanese Patent Application Publication No. 2002-191177

However according to the structure of the AC Adaptor, the first circuit board assembly is to be fixed to the right side of the case, the second circuit board assembly is to be fixed to the left side of the case, and the insulator member is to be fixed to the middle of the case such that the insulator member is positioned between the first circuit board assembly and the second circuit board assembly. Therefore, the AC Adaptor cannot be assembled with sufficient workability because the first circuit board assembly, the second circuit board assembly, and the insulator member are fixed to the case one by one.

In addition, because of the feature that each of the first circuit board assembly, the second circuit board assembly, and the insulator member are fixed to the case separately, it is necessary to provide some degree of gap between the first circuit board assembly and the insulator member and between the second circuit board assembly and the insulator member. Thus, the situation remains that the size of the AC adaptor is not reduced sufficiently.

### SUMMARY OF THE INVENTION

In light of the circumstance described above, the present invention may provide an AC adaptor that solves the problems.

According to one aspect of the present invention, there is provided an AC adaptor including a case (21) and a switching regulator circuit assembly (30) assembled and housed in the case, the switching regulator circuit assembly (30) including a plurality of circuit board assemblies (40,50), each circuit board assembly having a circuit board on which electronic parts are mounted and an insulator member (60) having electronic parts enclosing parts (67,68,70) for enclosing the electronic parts, whereby the circuit board assemblies (40,50) are fixed in place with the insulator member (60) disposed in between, and the electronic parts mounted on the circuit board assemblies are housed in the electronic parts enclosing parts (67,68,70).

It should be noted that the above reference numerals are provided for reference purposes only and thus do not limit the scope of the claims of the present invention.

According to another aspect of the present invention, since each of the circuit board assemblies is fixed to the insulator member, the switching regulator circuit assembly can be assembled with improved workability and the size thereof can be accordingly reduced. In addition, since the switching regulator circuit assembly is housed in the case, the size of the AC adaptor can be accordingly reduced and the AC adaptor also can be assembled with improved workability.

### BRIEF DESCRIPTION OF THE DRAWINGS

FIG. 1 is an exploded perspective view of an AC adaptor according to one embodiment of the present invention;

FIG. 2 is a cut-open side view of the AC adaptor;

FIG. 3 is an exploded view of the AC adaptor;

FIG. 4 is a cut-open side view of the switching regulator circuit assembly in FIG. 1 taken along the X-Z plane at the line IV-IV;

FIG. 5 is a circuit diagram of the switching regulator circuit assembly;

FIGS. 6A through 6C are views showing a first circuit board assembly;

FIGS. 7A through 7D are views showing a second circuit board assembly;

FIGS. 8A through 8B are perspective views showing an insulator member;

FIG. 9 is a perspective view showing the insulator member;

FIGS. 10A through 10F are drawings showing the insulator member;

FIGS. 11A through 11C are views illustrating how to assemble the switching regulator circuit assembly;

FIGS. 12A through 12B are views illustrating how to fix the insulator member to the first circuit board assembly; and

FIGS. 13A through 13B are views illustrating how to fix the insulator member to the second circuit board assembly.

### DETAILED DESCRIPTION OF THE PREFERRED EMBODIMENTS

Next, an embodiment of the present invention is explained.

### Example 1

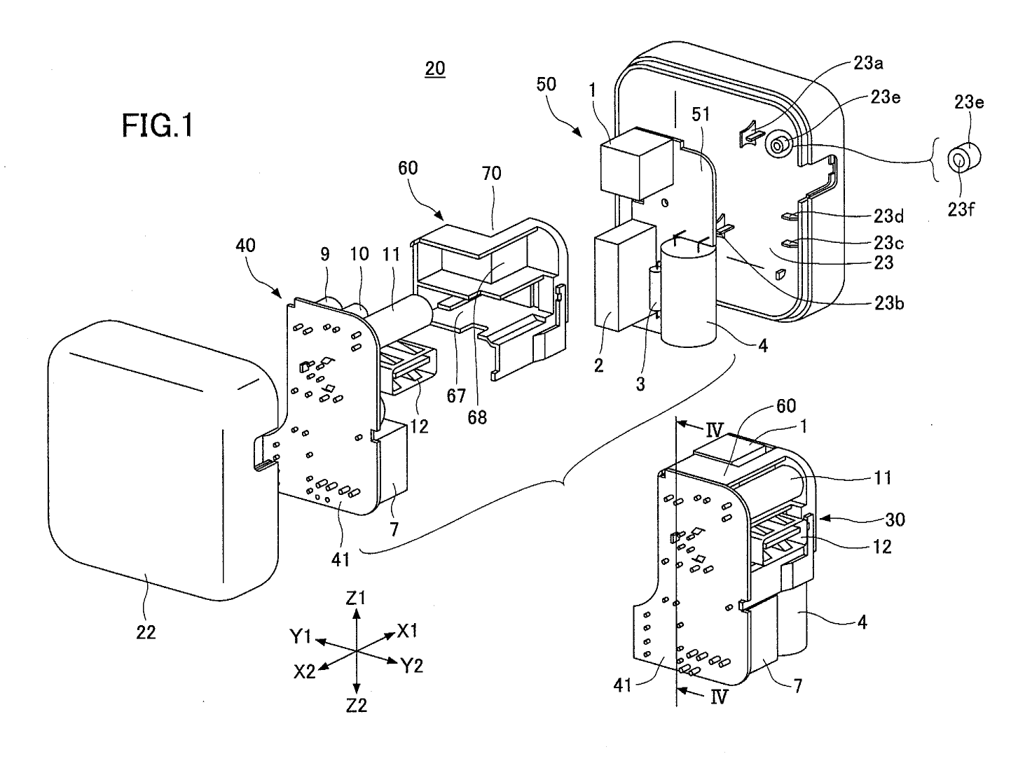

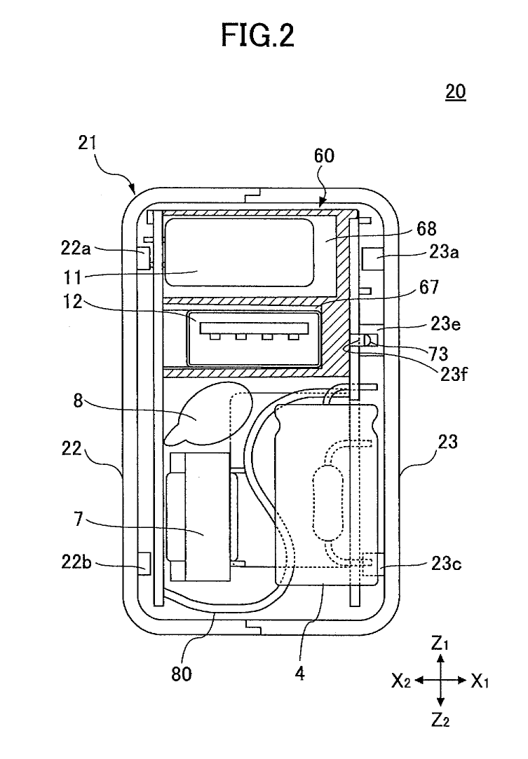

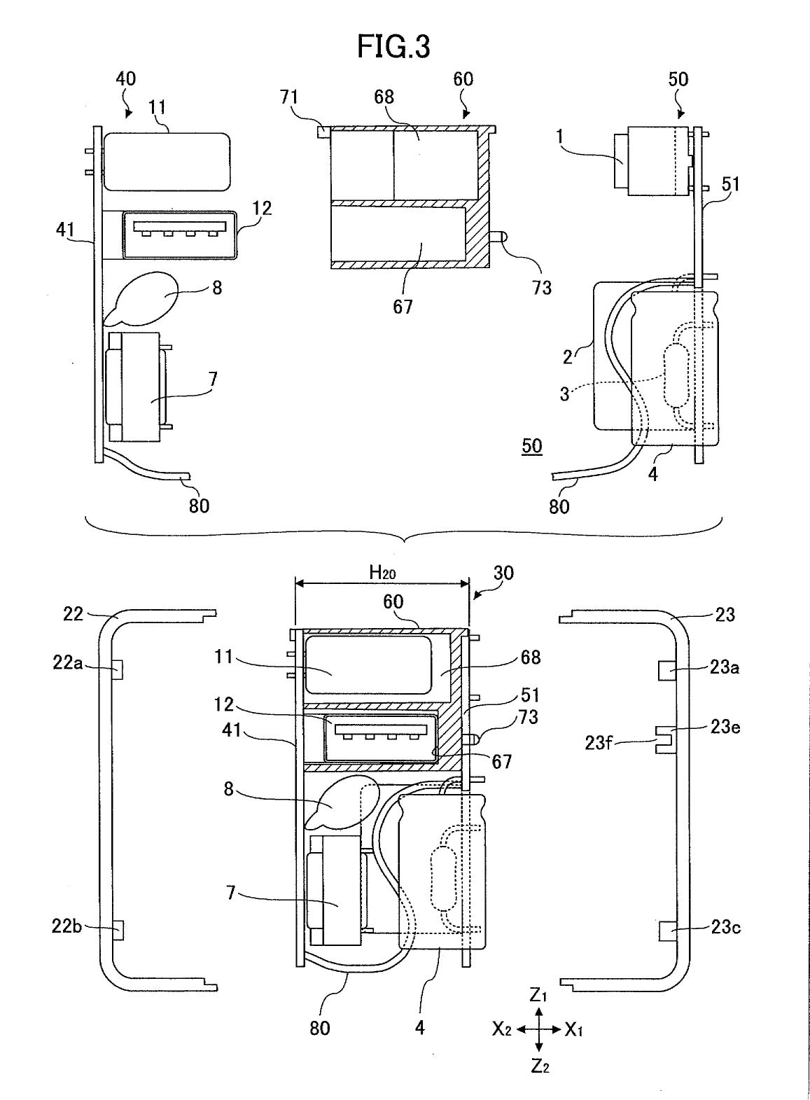

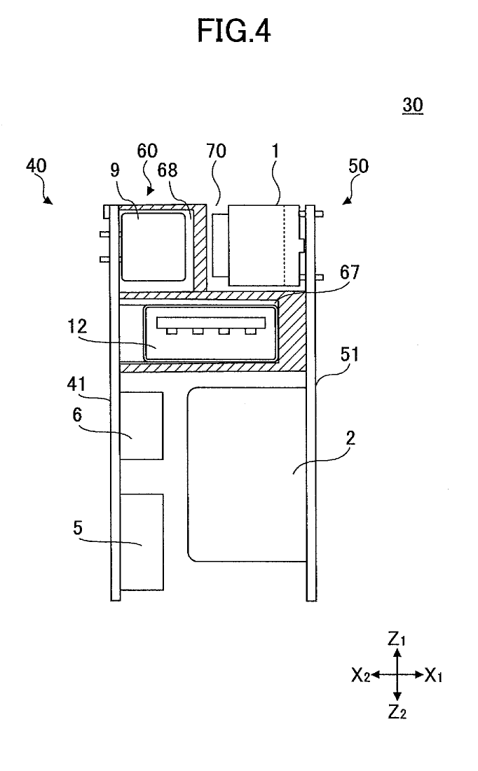

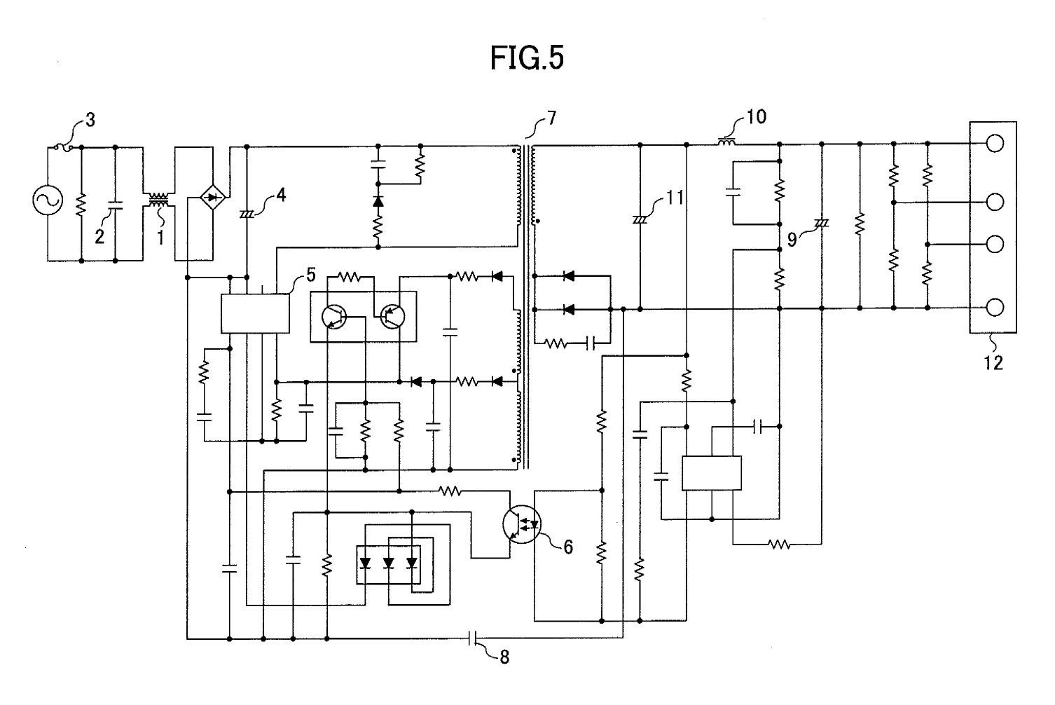

FIG. 1 is an exploded perspective view of an AC adaptor 20 according to one embodiment of the present invention. FIG. 2 is a cut-open side view of the AC adaptor 20. FIG. 3 is an exploded view of the AC adaptor 20. FIG. 4 is a cross-sectional view of the switching regulator circuit assembly 30 in FIG. 1 taken along the X-Z plane at the line IV-IV. FIG. 5 is a circuit diagram of the switching regulation circuit assembly 30.

The AC adaptor 20 includes the switching regulator circuit assembly 30, assembled in advance, having a substantially cube-shaped body, and housed within a case 21. In the drawings, X1-X2 direction denotes the width direction, Y1-Y2 direction denotes the depth direction, and the Z1-Z2 direction denotes the height direction.

The switching regulator circuit assembly 30 includes an insulator member 60, a first circuit board assembly 40, and a second circuit board assembly 50. The assemblies are to be disposed opposite to each other with the insulator member 60 disposed in between.

The case 21 is made up of two half cases 22 and 23 joined together. On the inner side of the half case 22, engaging parts 22a, 22b are formed for fixing the position of the switching regulator circuit assembly 30. On the inner side of the half case 23, engaging parts 23a through 23d, a hole 23f and a protruding part 23e are formed. The protruding part 23e has the hole formed for fixing a position of the switching regulator circuit assembly 30 in the case 21.

### [Structure of the First Circuit Board Assembly 40]

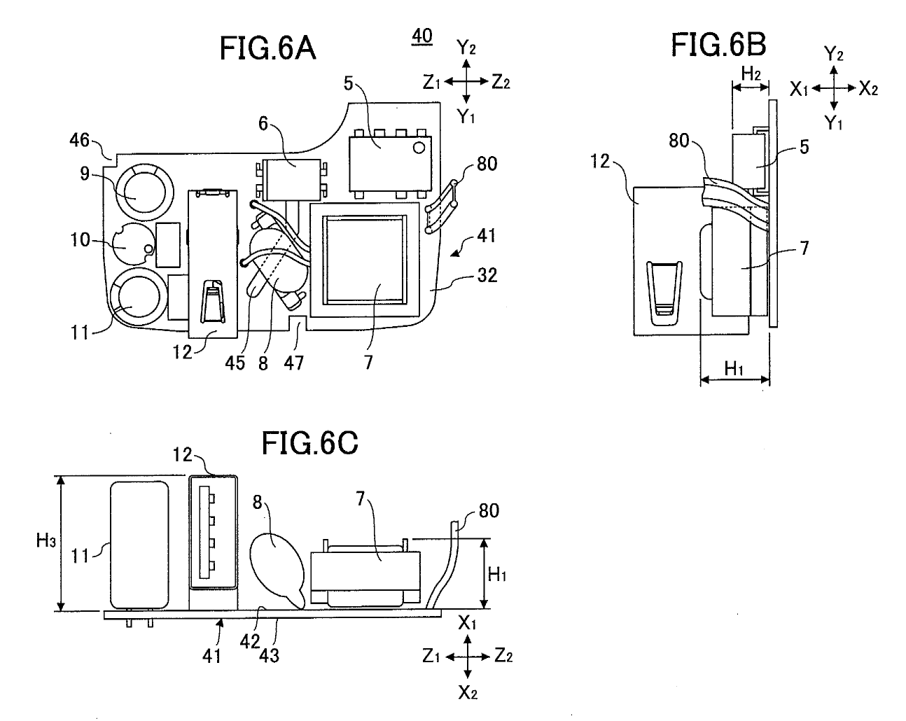

As shown in FIGS. 6A through 6C, the first circuit board assembly 40 includes a first circuit board 41 having surfaces 42 and 43. On the Z2 side of the surface 42, a transformer member 7, a forming IC 5, a cutting IC 6, and a cutting capacitor 8 are mounted. In the same manner, on the Z1 side of the same surface 42 are mounted a cutting capacitor 11, a coil 10, a cutting capacitor 9, and a USB connector 12 which is an output terminal member. As shown in FIG. 6B, on the Z2 side, short (in height) electronic parts (a transformer member 7, a forming IC 5, a cutting IC 6, and a cutting capacitor 8) each having H1 or H2 height are disposed. On the Z1 side, tall electronic parts (a cutting capacitor 11, a coil 10, a cutting capacitor 9, and a USB connector 12) each having H3 height are disposed. Reference number 80 denotes a cable extending from near an edge on the Z2 side of the surface 42 of the first circuit board 41.

At a substantially middle of the first circuit board 41, a slit 45 extending along the Y1-Y2 direction for shielding is formed. On the first circuit board 41, notch parts 46 and 47 are formed for engaging with foot parts formed on the insulator member 60.

### [Structure of the Second Circuit Board Assembly 50]

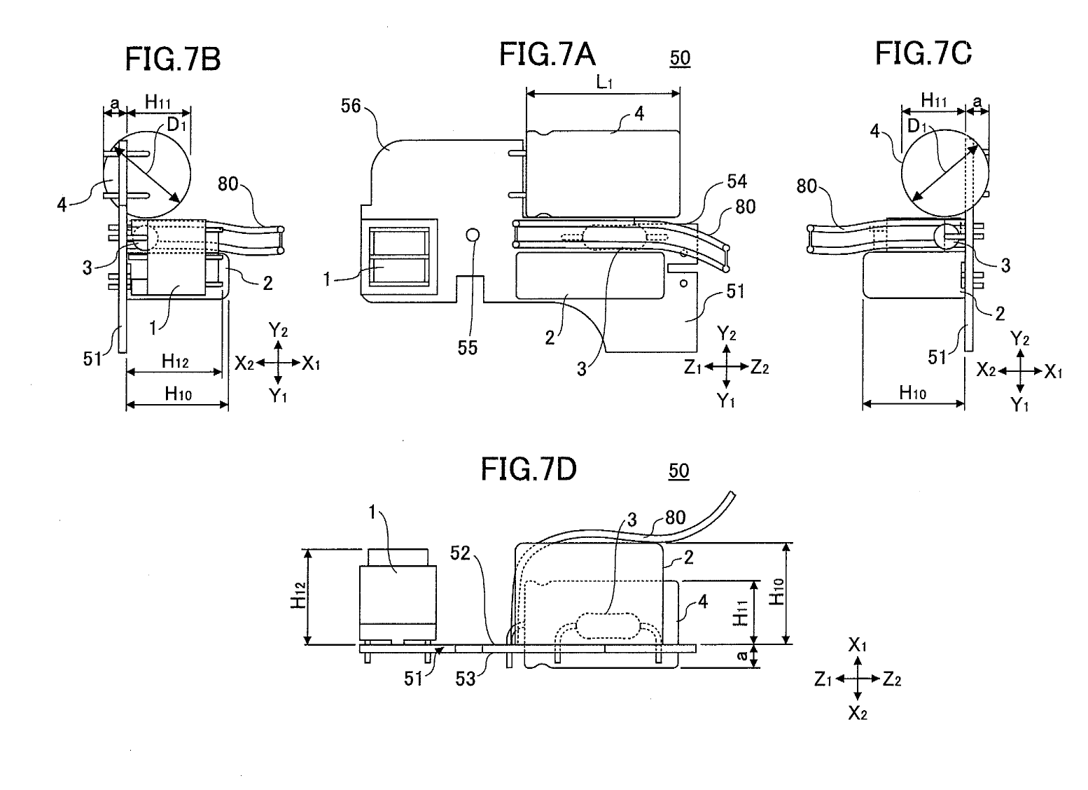

As shown in FIGS. 7A through 7D, the second circuit board assembly 50 includes a second circuit board 51 having surfaces 52 and 53. On the Z2 side of the surface 52, a cutting capacitor 2, a forming fuse 3, and a forming capacitor 4 are mounted. On the Z1 side of the same surface 52, a line filter 1 is mounted. On the Z2 side, a tall cutting capacitor 2 having H10 height is disposed. On the Z1 side, a short (in height) line filter 1 having H12 height is disposed. Since the forming capacitor 4 is long-shaped with the dimensions of diameter D1 and the length L1, the forming capacitor 4 is arranged to be laid down so as to be engaged into a notch part 54 of the second circuit board 51. In this mounting structure, a part of the forming capacitor 4 is projected from the surface 53 of the second circuit board 51 by the length ‘a’, thereby reducing the height to H11. The cable 80 passes through between the cutting capacitor 2 and the forming capacitor 4 and is connected to the middle of the surface 52 of the second circuit board 51.

At a substantially middle of the second circuit board 51, a hole 55 is formed to be engaged with a protruding part of the insulator member 60. Also, at a corner of Z1 and Y2 of the second circuit board 51, an arc-shaped edge part 56 is formed to be engaged with an arc-shaped rib part of the insulator member 60.

Electronic parts mounted on each of the first circuit board assembly 40 and the second circuit board assembly 50 are arranged so that, when the electronic parts on each assembly are facing each other, the short (in height) electronic parts on the first circuit board assembly 40 and the tall electronic parts on the second circuit board assembly 50 are facing each other; in the same way, the tall electronic parts on the first circuit board assembly 40 and the short electronic parts on the second circuit board assembly 50 are facing each other.

The size of the first circuit board 41 and the second circuit board 51 is substantially half that of a circuit board used when a switching regulator circuit assembly includes only one circuit board assembly.

### [Structure of the Insulator Member 60]

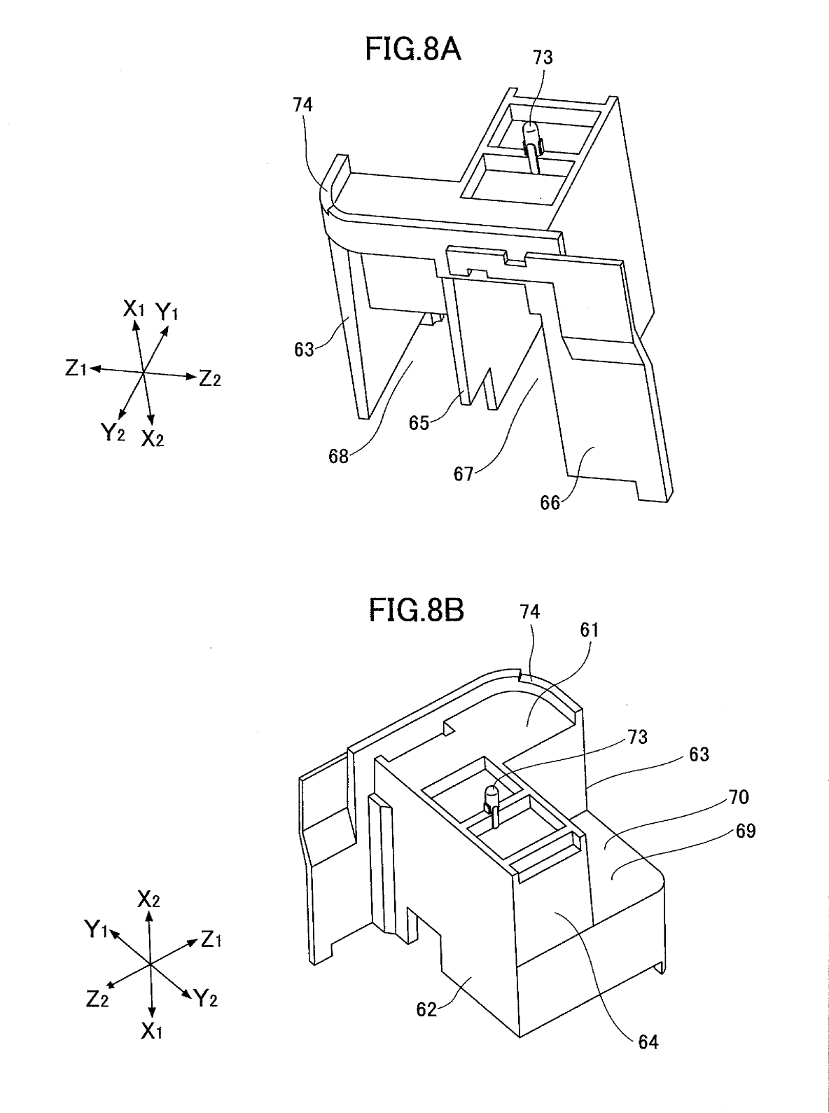

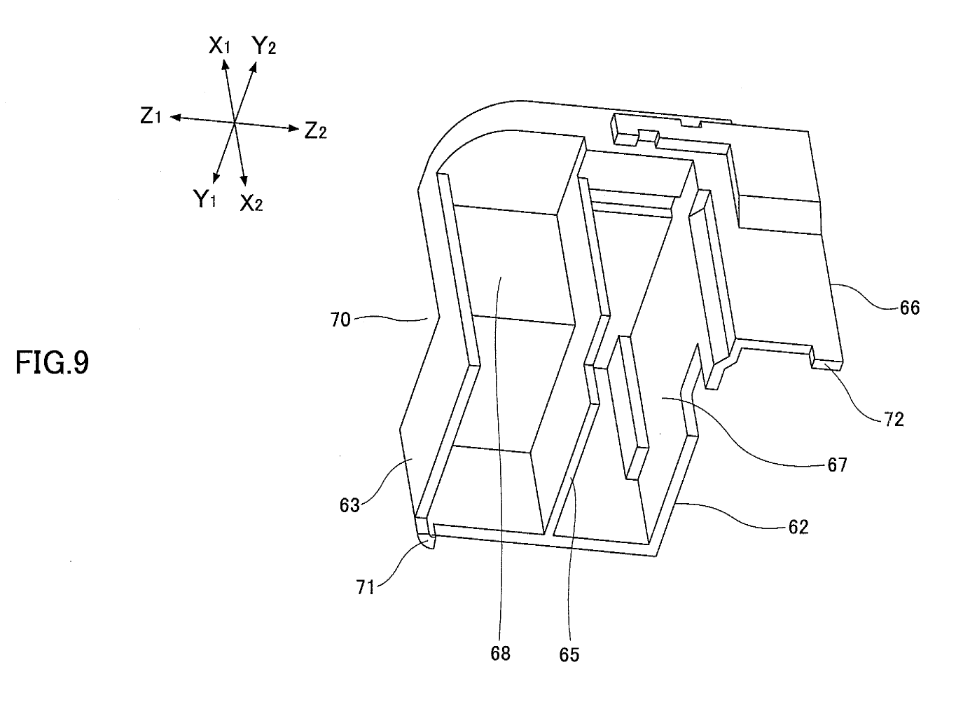

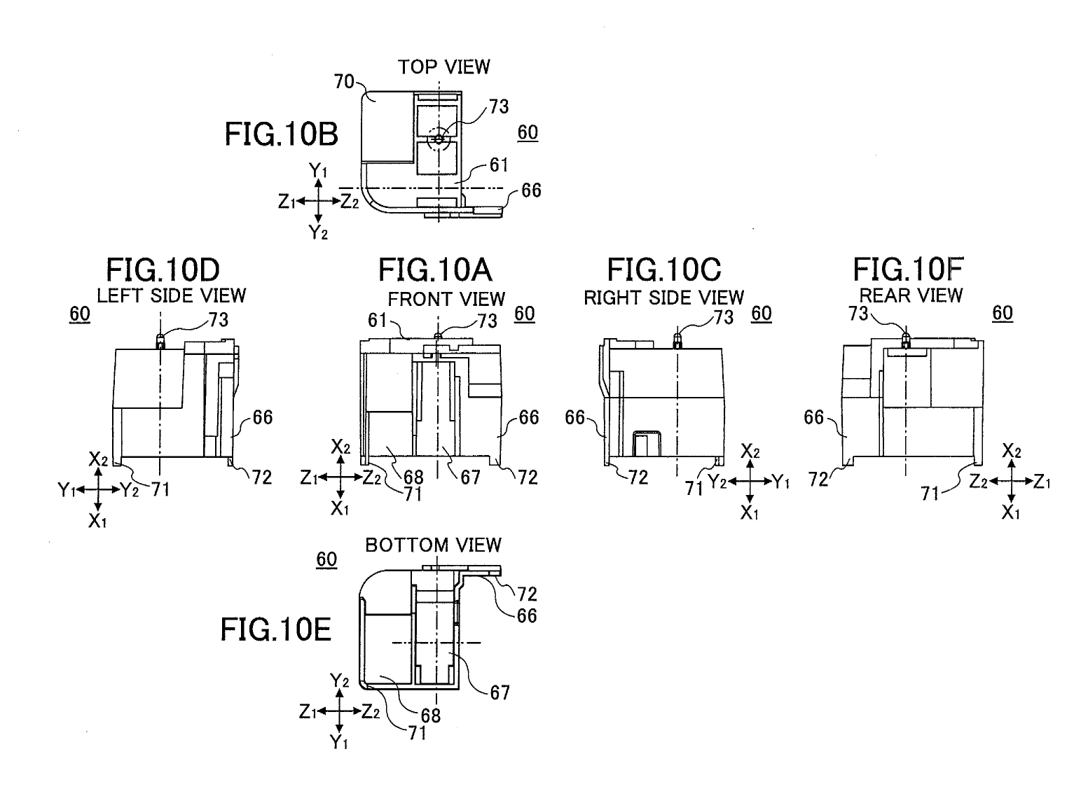

FIG. 8A is an oblique perspective view of the insulator member 60 from the upper front. FIG. 8B is an oblique perspective view of the insulator member 60 from the upper rear. FIG. 9 is an oblique perspective view of the insulator member 60 from the lower front. FIGS. 10A through 10F are orthographic figures of the insulator member 60.

The insulator member 60, made of a material having electrical insulating properties and synthetic resin molding parts having a substantially cube-shaped body, includes a top panel part 61 on the X1 side, side panel parts 62,63 one on each side, a rear panel part 64, a partitioning panel part 65 for partitioning between the side panel parts 62 and 63, and an extended panel part 66 on the front (Y2 side), and has openings on front (Y2 side) and bottom (X2 side).

The side panel parts 62, the partitioning panel part 65, and the top panel part 61 form an enclosing part 67 for enclosing the USB connector 12. Similarly, the side panel part 63, the partitioning panel part 65, and the top panel part 61 form an enclosing part 68 for collectively enclosing the cutting capacitor 11, the coil 10, and the cutting capacitor 9. The enclosing parts 67 and 68 are adjacent to each other. The height of the enclosing part 68 on the rear panel side is lowered by one step due to a top panel part 69. On the upper side of the top panel part 69, another enclosing part 70 is formed for enclosing the line filter 1. Namely, the insulator member 60 includes an enclosing part on each of the X2 and X1 sides.

The extended panel part 66 extends from an end of the enclosing part 67 in the Z2 direction.

At an end of the side panel part 63 in X2 direction and at an end of the extended panel part 66 in X2 direction, foot parts 71 and 72, respectively, are formed.

A protruding part 73 is formed at substantially the middle of the top panel 61, and an arc-shaped rib part 74 is formed at a corner of Z1 and Y2 of the top panel 61.

### [Assembly of the Switching Regulator Circuit Assembly 30]

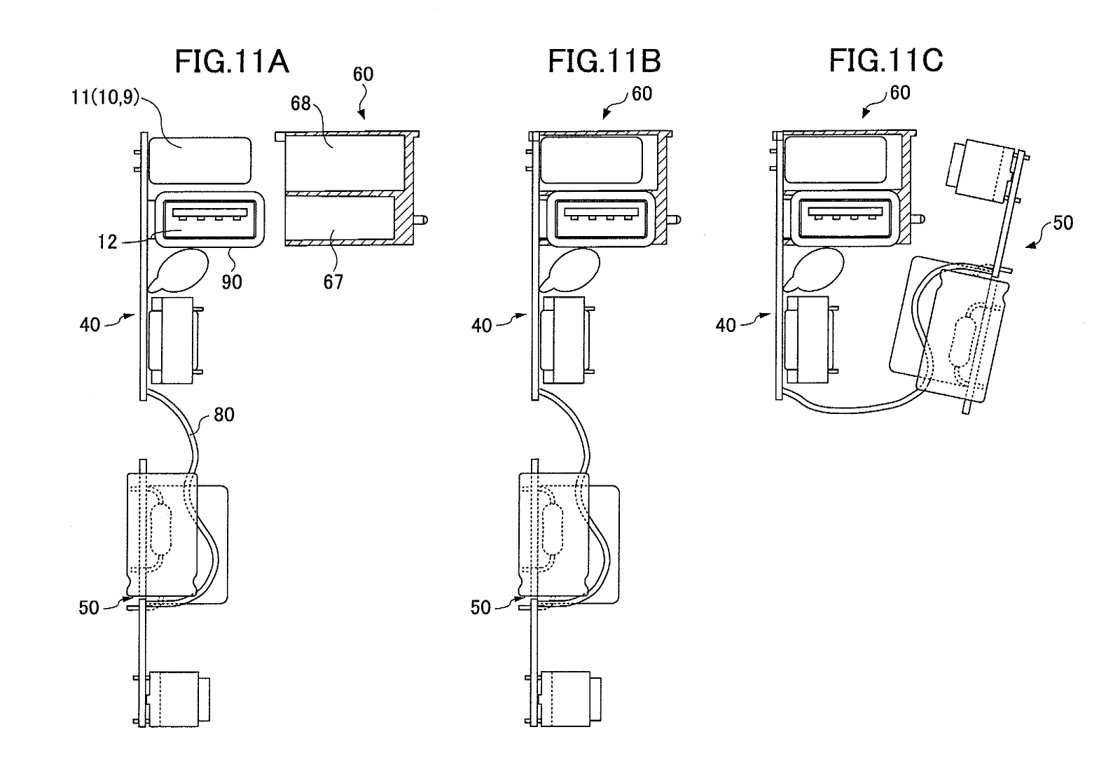

Next, a method of assembling the switching regulator circuit assembly 30 and the like are explained with reference to FIG. 11.

As shown in FIG. 11, the switching regulator circuit assembly 30 is assembled in two steps explained below.

As shown in FIG. 11A, the first circuit board assembly 40 and the second circuit board assembly 50 are connected to each other using the cable 80, and the second circuit board assembly 50 can be fit in place with the first circuit board assembly 40 when the second circuit board assembly 50 is turned upside down and put over the first circuit board assembly 40.

A first step: The insulator member 60 is put over the first circuit board assembly 40.

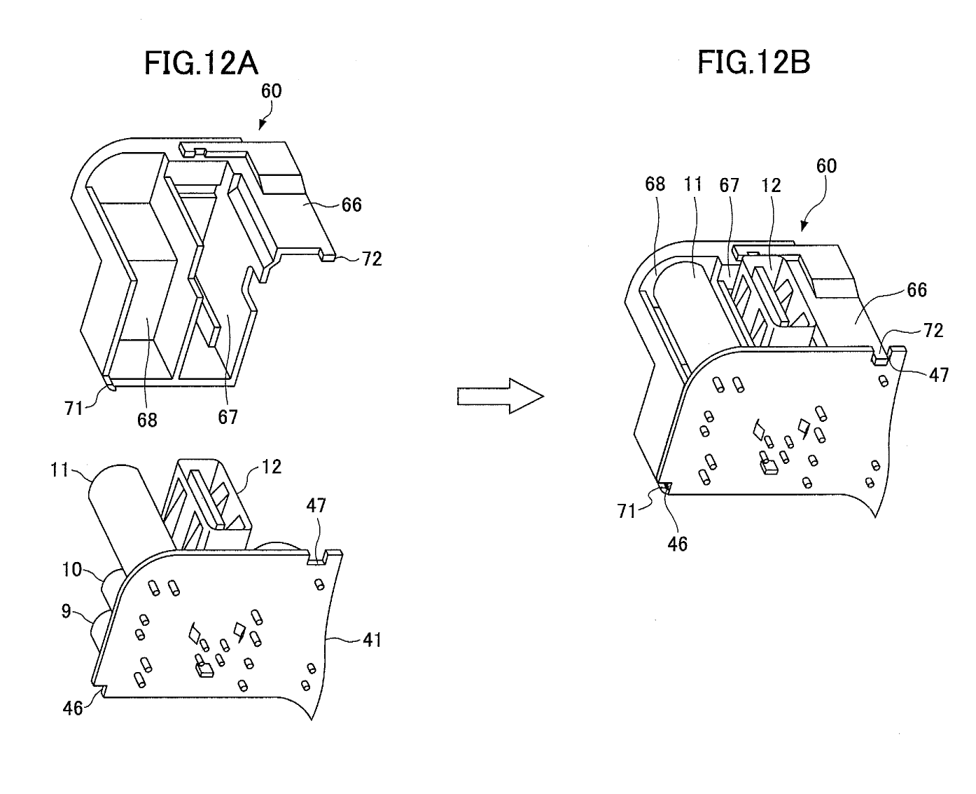

As shown in FIGS. 11A and 12A, a frame member 90 made of synthetic resin is engaged with the outer side of an input part of the USB connector 12. To engage the insulator member 60 with the first circuit board assembly 40, the enclosing part 67 of the insulator member 60 is placed to enclose the USB connector 12 and the enclosing part 68 is placed to collectively enclose the cutting capacitor 11, the coil 10, and the cutting capacitor 9. The foot parts 71 and 72 are engaged by the notches 36 and 37, respectively. FIGS. 11B and 12B show where the insulator member 60 is engaged in place with the first circuit board assembly 40.

A second step: The second circuit board assembly 50 is put over the first circuit board assembly.

As shown in FIG. 11C, the second circuit board assembly 50 is turned upside down and put in place over the insulator member 60 so as to fit over the first circuit board assembly 40.

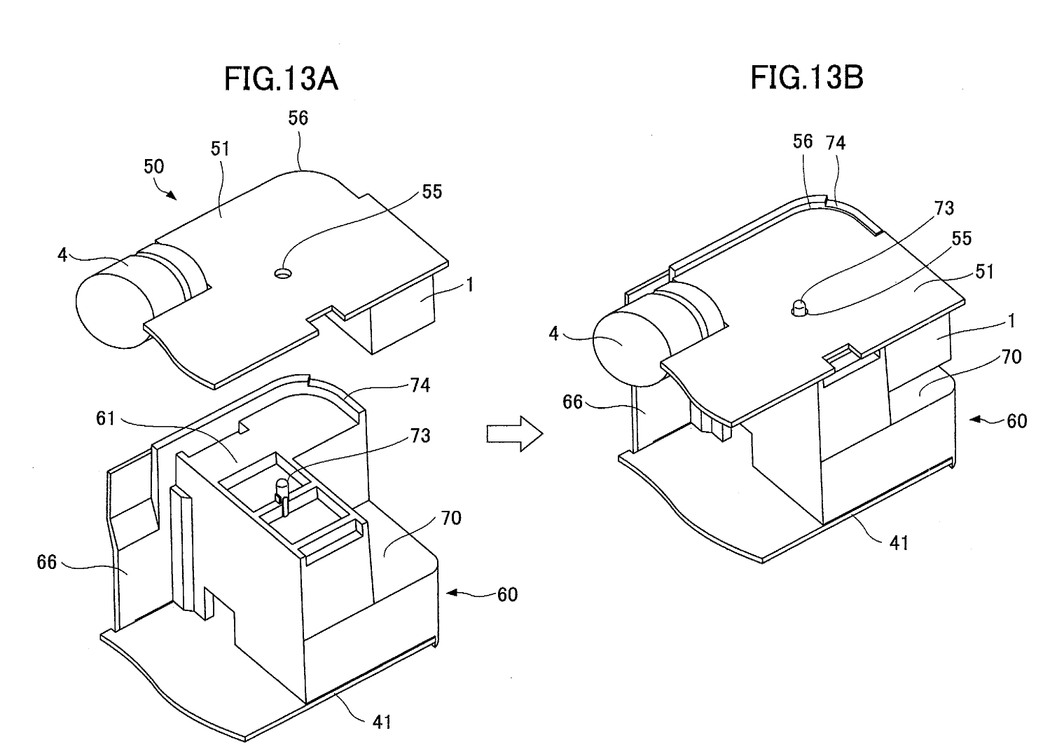

As shown in FIGS. 13A and 13B, the position of the second circuit board assembly 51 is fixed when the protruding part 73 is engaged with the hole 55 and the arc-shaped edge part 56 is fit inside the arc-shaped rib part 74.

The line filter 1 is housed within the enclosing part 70. The forming capacitor 4 and the transformer member 7 are disposed opposite to each other and the cutting capacitor 2 and the forming IC 5 are disposed opposite to each other.

By the above steps, the assembly of the switching regulator circuit board assembly 30 shown in FIGS. 1 and 3 is completed. As a result of the assembly, the first circuit board 41 and the insulator member 60 are closer to each other and the second circuit board 51 and the insulator member 60 are closer to each other. Thus, the length H20 of the switching regulator circuit assembly 30 shown in FIG. 3 is minimized and accordingly the size of the switching regulator circuit board assembly 30 is reduced.

In addition, the insulator member 60 enables securing sufficient creepage distances between the USB connector 12 and the cutting capacitor 11, the coil 10, and the cutting capacitor 9; between the USB connector 12, the cutting capacitor 11, the coil 10 and the cutting capacitor 9 and the line filter 1; and between the USB connector 12 and the cutting capacitor 8, the forming capacitor 4, the transformer member 7, the cutting capacitor 2, and the forming IC 5. The extending panel part 66 is extended toward the transformer member 7 and encloses the cutting capacitor 8.

### [Assembly of the AC Adaptor 20]

Next, a method of assembling the AC adaptor 20 is explained.

The assembly of the AC adaptor 20 is completed when the switching regulator circuit assembly 30 is housed into the half case 22 and the half case 23 is combined with the half case 22.

As shown in FIG. 2, the switching regulator circuit board assembly 30 is engaged with the half case 22 by means of engaging parts 22a and 22b which are engaged with an edge of the first circuit board 41. In the same manner, the switching regulator circuit board assembly 30 is engaged with the half case 23 by means of engaging parts 23a to 23d which are engaged with an edge of the second circuit board 51, a protruding part 73 which is engaged with the hole 23f of the projection 23e, and the projection 23f which presses in the vicinity of the hole 55 of the second circuit board assembly 51.

In addition, the insulator member 60 may have a heat dissipation capability by selecting an appropriate material for the insulation member 60. In such a case, the switching regulator circuit board assembly 30 becomes compact and has better heat dissipation capability as well.

In addition, by changing the shape of the insulator member 60, a switching regulator circuit assembly may have a first, a second, and a third circuit board assemblies each engaged with an insulator member provided in between.

In addition, an insulator member may be made up by combining block parts.

Though an exemplary embodiment is described in detail above, the present invention is not limited to the specific embodiment described above, and variations and modification may be made without departing from the spirit and scope of the present invention.

The present invention is based on Japanese priority application No. 2006-236026 filed Aug. 31, 2006, the entire contents of which are hereby incorporated herein by reference.

What is claimed is:

1. An AC adaptor comprising:
a case; and
a switching regulator circuit assembly, assembled and housed in the case, including
a plurality of circuit board assemblies each circuit board assembly including a circuit board on which electronic parts are mounted; and
an insulator member including an electronic parts enclosing part for enclosing the electronic parts; wherein:
the circuit board assemblies are fixed in place with the insulator member disposed therebetween; and
the electronic parts mounted on the circuit board assemblies are housed in the electronic parts enclosing part.

2. An AC adaptor comprising:
a case; and
a switching regulator circuit assembly, assembled and housed in the case, including
a first circuit board assembly including a first circuit board on which electronic parts are mounted;
a second circuit board assembly including a second circuit board on which electronic parts are mounted; and
an insulator member including an electronic parts enclosing part for enclosing the electronic parts; wherein:
the first circuit board assembly and the second circuit board assembly are fixed in place with the insulator member disposed in between the assemblies; and
the electronic parts mounted on the first and the second circuits board assemblies are housed in the electronic parts enclosing part.

3. The AC adaptor according to claim 2, wherein the insulator member includes one of the electronic parts enclosing part formed on each side thereof.

4. The AC adaptor according to claim 2, the insulator member further including:
a first circuit board fixing part provided on one side of the insulating member for engaging with and fixing to the first circuit board; and
a second circuit board fixing part provided on the other side of the insulating member for engaging with and fixing to the second circuit board; wherein:
in the switching regulator circuit board assembly, the first circuit board of the first circuit board assembly is engaged with and fixed to the first circuit board fixing part of the insulator member; and
the second circuit board of the second circuit board assembly is engaged with and fixed to the second circuit board fixing part of the insulator member.

5. The AC adaptor according to claim 2, wherein:
the insulator member is made of a material having electrical insulating properties and synthetic resin molding parts having a substantially cube-shaped body, the insulator member further including:
a top panel part including a protruding part; and
a side panel part including a foot part at the end thereof;
the first circuit board including a part having a notch;
the second circuit board including a part having a hole; and
in the switching regulator circuit assembly, the notch of the first circuit board of the first circuit board assembly is engaged with and fixed to the foot part of the insulator member and the hole of the second circuit board of the second circuit board assembly is engaged with and fixed to the protruding part of the insulator member.

6. The AC adaptor according to claim 1, wherein the case includes an engaging part formed on an inner surface thereof and the switching regulator circuit board assembly is engaged with and fixed to the case by means of the engaging part.

7. The AC adaptor according to claim 1, the circuit board further including a part having a slit for electric isolation.
